(19) United States
(12) Patent Application Publication
(10) Pub. No.: US 2023/0174437 A1
(43) Pub. Date: Jun. 8, 2023

(54) BIO-PHOSPHATE FERTILIZER FORMULATION WITH FULL OF LIFE FOR CROP NUTRITION, CROP PRODUCTIVITY AND SOIL FERTILITY

(71) Applicant: Basavaraj Girennavar, Doddaballapura-Tq, Bengaluru Rural (IN)

(72) Inventors: Basavaraj GIRENNAVAR, Bengaluru Rural (IN); Amitha GANAPATHY B, Kodagu (IN)

(21) Appl. No.: 17/924,523

(22) PCT Filed: Jul. 12, 2020
(86) PCT No.: PCT/IB2020/056534

§ 371 Date: Nov. 10, 2022

(30) Foreign Application Priority Data
May 10, 2020 (IN) 202041019739

(51) Int. Cl. C05F 11/08; C05B 17/00; C05G 5/12; C05G 5/30

(52) U.S. Cl. CPC C05F 11/08; C05B 17/00; C05G 5/12; C05G 5/30

(57) ABSTRACT

The present invention relates to the Bio-Phosphate fertilizer formulation for crop nutrition, crop productivity, and soil fertility. It particularly relates to the Bio-Phosphate fertilizer formulation which comprises phosphate solubilizing and plants growth-promoting microorganisms, rock phosphate, bentonite along with minerals, macro, and micronutrients. It specifically relates to the Bio-Phosphate fertilizer formulation containing Phosphate Solubilizing Microorganisms are selected from a combination of Phosphate Solubilizing bacteria selected from Bacillus spp., & Pseudomonas spp., and Phosphate Solubilizing fungi selected from Aspergillus spp., The invention further relates to the process for the preparation of Bio-Phosphate fertilizer formulation for sustainable agriculture along with increasing the crop nutrition, crop productivity, and soil fertility.

### FIELD OF THE INVENTION

The present disclosure relates to the Bio-Phosphate fertilizer formulation with full of life for crop nutrition, crop productivity and soil fertility. It particularly relates to the Bio-Phosphate fertilizer formulation which reduces the use of chemical fertilizer and increase nutrients use efficiency and Phosphorus bio-availability for better crop productivity and sustainable agriculture. It specifically relates to the Bio-Phosphate fertilizer formulation containing phosphate in the form of P₂O₅, microbes especially phosphate solubilizers such as Bacillus spp, Pseudomonas spp, fungi in the form of spores Aspergillus spp and Trichoderma spp, complex media of Amino Acids, proteins, salts, minerals and Carbohydrates, plant growth promoting inputs such as humate and seaweed. The invention also relates to the process for preparation of the Bio-Phosphate fertilizer formulation with full of life for crop nutrition, crop productivity and soil fertility. The invention further relates to the method for management of plant growth or crops by using Bio-Phosphate fertilizer formulation with full of life for crop nutrition, crop productivity and soil fertility.

### BACKGROUND OF THE INVENTION

Phosphorus (P) is an essential element for all living organisms. As a component of every living cell, P is indispensable because no other element can replace it in its vital role in many physiological and biochemical processes. Therefore, the production of crops for food, feed, fuel and fiber requires an adequate supply of P in the soil.

Phosphate accounts for between 0.2 and 0.8% of the dry weight of plants. It is a crucial component for converting solar energy into food, fiber and other plant products. Also plays a key role in the metabolism of sugars, energy storage and transfer, cell growth and the transfer of genetic information. P is essential in every aspect of plant growth and development of all plants. Helps in stimulating root development, increases stalk and stem strength, improves flower formation and seed production, more uniform and earlier crop maturity, increases N-fixing capacity of legumes, improvements in crop quality, increases resistance to plant diseases and supports development throughout entire life cycle.

Despite P being quite abundant in many soils, it is largely unavailable for plant uptake because P forms insoluble complexes with cations under acid and alkaline conditions. As a result, a large amount of inorganic P fertilizers has been applied for crop production. The over-use of chemical fertilizers can lead to soil acidification and soil crust thereby reducing organic matter content, humus content, beneficial organisms, stunting plant growth, change the soil pH, increase pests, and even contribute to the release of greenhouse gases. The soil acidity diminishes phosphate intake by crops, increases the toxic ion concentration in the soil, and inhibits crop growth. Due to repeated applications of chemical fertilizer will result in a toxic buildup of heavy metals and fertilizer filler materials in the soil. These toxic heavy metals and filler materials not only pollute the soil but also get accumulated in food grains, fruits and vegetables, impacting the quality of the food produced.

Presently, most of the dissolved inorganic phosphate is given as chemical fertilizers, which is quickly being immobilized in the soil and cannot be absorbed by plants. The soil fixed P can only be solubilized by phosphate solubilizing microorganisms like Pseudomonas, Bacillus and Rhizobium spp. These bacteria are effective in releasing P both organic and the inorganic from the total P soil through a process of dissolution and mineralization which make P soluble and available to plants.

There are several prior arts which reported the role of biofertilizers or organic formulations in phosphate solubilization, mobilization of nutrients for crop production and sustainable agriculture and the important ones include E. Leo Daniel Amalraj, S. Maiyappan and A. John Peter, Journal of Ecobiotechnology 2012, 4(1): 35-42; Dr. Pallabi Mishra and Dr. Debiprasad Dash, Consilience: The Journal of Sustainable Development, Vol. 11, Iss. 1 (2014), Pp. 41-61; Sandra Stamenković Stojanović, Ivana Karabegović, Vladimir Beškoski, Nada Nikolić and Miodrag Lazić, Hem. Ind. 73 (3) 169-182 (2019); Manashi Barman, Srijita Paul, Aditi Guha Choudhury, Pinaki Roy and Jahnavi Sen, Int. J. Curr. Microbiol. App. Sci (2017) 6(11): 1177-1186; Rakesh Kumar, Narendra Kumawat and Yogesh Kumar Sahu, Popular Kheti, Volume-5, Issue-4 (October-December), 2017; Jing Zhu a, Min Li a,*, Mick Whelan, Science of the Total Environment 612 (2018) 522-537; Itelima J U, Bang W J, Onyimba I A, A review: biofertilizer; a key player in enhancing soil fertility and crop productivity. J Microbiol Biotechnol Rep. 2018; 2(1):22-28; S. S. Sheraz Mandi, G. I. Hassan, S. A. Samoon, H. A. Rather, Showkat A. Dar5 and B. Zehra, Bio-fertilizers in Organic Agriculture. J Phytol 2/10 (2010) 42-54; Seema B Sharma, Riyaz Z Sayyed, Mrugesh H Trivedi and Thivakaran A Gobi, SpringerPlus 2013, 2:587; Mohammad Galavi, Khatoon Yosefi & Mahmod Ramrodi, Journal of Agricultural Science Vol. 3, No. 4; December 2011; Amadou Hamadoun Babana, Adounigna Kassogué, Amadou Hamadoun Dicko, Kadia Maîga, Fassé Samaké, Diakaridia Traoré, Rokiatou Fané, Fatouma A. Faradji, Procedia Engineering 138 (2016) 319-324; Deepak Bhardwaj†, Mohammad Wahid Ansari†, Ranjan Kumar Sahoo and Narendra Tuteja, Microbial Cell Factories 2014, 13:66; Satinder Kaur Brar, Saurabh Jyoti Sarma and Emna Chaabouni, J Biofertil Biopestici 2012, 3:5; Deepshikha Thakur, Rajesh Kaushal and Vineet Shyam, Agri. Review, 35 (3): 159-171, 2014; Sneha S, Anitha B, Anjum Sahair R, Raghu N, Gopenath T. S, Chandrashekrappa G K and Kanthesh M Basalingappa, Academia Journal of Agricultural Research 6(8): 299-306, August 2018; Sudhanshu Verma*, Abhishek Singh, Swati Swayamprabha Pradhan, R. K. Singh and J. P. Singh, Int. J. Curr. Microbiol. App. Sci (2017) 6(5): 648-665; Cheng-Hsiung Chang, Shang-Shyng Yang, Bioresource Technology 100 (2009) 1648-1658; and Qing Yao, Xiaolin Li, Gu Feng & Peter Christie, Plant and Soil 230: 279-285, 2001.

The patents or patent applications of interest which reported on the biofertilizer and their compositions or formulations include U.S. Pat. No. 5,026,417 which discloses a method and composition for increasing the amounts of phosphorus and/or micronutrients available for up take by plants from the soil. The invention involves introducing an inoculum of the fungus Penicillium bilaji into (or onto) the soil. This has the effect of increasing the solubility of phosphates and micronutrient sources which may be either native to the soil or added to it, e.g. in the form of insoluble rock phosphate or manufactured phosphate fertilizer. The invention can be used to increase the health, growth rates and yields of plants, especially crop plants grown on nutrient-deficient soils, while eliminating or minimizing the need for expensive manufactured fertilizers.

The U.S. Pat. No. 5,256,544 discloses a process for solubilizing phosphate from phosphate containing ore by treatment with microorganisms which comprises forming an aqueous mixture of phosphate ore, microorganisms operable for solubilizing phosphate from the phosphate ore and maintaining the aqueous mixture for a period of time and under conditions operable to effect the microbial solubilization process. An aqueous solution containing soluble phosphorous can be separated from the reacted mixture by precipitation, solvent extraction, selective membrane, exchange resin or gravity methods to recover phosphate from the aqueous solution.

The U.S. patent application no. US 2019/0200644 A1 which discloses a product form comprises an inanimate substrate comprising i) an active agent; and ii) carrier particles including at least an outer surface comprising an organic matter constituent, wherein the said active agent is combined within and/or on the surface of the carrier particles, the carrier particles being a) in dry, particulate form and carrying at least an electrostatic surface charge, and b) being at least substantially uniformly distributed over the outer surface of the substrate.

The PCT patent application publication no. WO9506623 A1 which discloses methods of increasing the solubilisation of phosphate materials, particularly rock and insoluble phosphate fertiliser materials. A preferred composition incorporates a phosphate solubilising fungus, microorganism or reproductive material therefor, along with a nutrient capable of supporting same, into a phosphate material. Protein based nutrients, including fish based fertilising compositions have been found quite suitable. Variations include the introduction of free ammonia releasing microorganisms. Preferred embodiments of a composition are substantially dry, flowable, particles which may be coated with various agents. Also disclosed are methods for the preparation of such a composition, and the use of such compositions in increasing plant available phosphorus in soil.

The PCT patent application publication no. WO 2010/037228 A1 which discloses a method of enhancing growth conditions for plants by growing the plants in soil containing, in proximity to the plant roots, both a phosphorus source and at least two strains of the fungus Penicillium, particularly P. bilaiae, more particularly strains NRRL 50162 and NRRL 50169.

The PCT patent application publication no. WO 20M1078647 A1 which discloses invention related to novel phosphate solubilizing strains as well as compositions and methods thereof for increasing the availability of phosphate for plants.

Though there are several prior arts which reported for the Biofertilizer and its formulations for crop nutrition and sustainable agriculture but none of the prior arts in the literature reported or disclosed the liquid or powder or granular form of Bio-Phosphate fertilizer formulation with full of life for crop nutrition, crop productivity and soil fertility. Also, the prior arts reported are having the several drawbacks of their own for application in the fields for crop nutrition, crop productivity and soil fertility in sustainable agriculture. Thus, there is a need for a development of suitable Bio-Phosphate fertilizer formulation with full of life for crop nutrition, crop productivity and soil fertility. Therefore, the present inventors developed the Bio-Phosphate organic formulation for crop nutrition, crop productivity and Soil fertility which reduces the use of chemical fertilizer and increase nutrients use efficiency of Phosphorus bio-availability for better crop productivity and sustainable agriculture.

### OBJECTIVES OF THE INVENTION

The primary object of the invention is to develop Bio-Phosphate fertilizer formulation with full of life for crop nutrition, crop productivity and soil fertility.

The particular object of the present invention is to develop Bio-Phosphate fertilizer formulation which reduces the use of chemical fertilizer and increase nutrients use efficiency and Phosphorus bio-availability for better crop productivity and sustainable agriculture.

The specific object of the present invention is to develop the Bio-Phosphate fertilizer formulation in the liquid or powder or granular form containing phosphate in the form of P₂O₅, microbes especially phosphate solubilizers such as Bacillus spp, Pseudomonas spp, fungi in the form of spores Aspergillus spp and Trichoderma spp, complex media of amino acids, proteins, salts, minerals and carbohydrates.

The further object of this invention is to provide a natural alternative organic formulation product which increases the Phosphorus and other nutrients bio-availability to the plant for better crop productivity and sustainable agriculture.

The further object of this invention is to develop a process for preparation of the Bio-Phosphate fertilizer formulation with full of life for crop nutrition, crop productivity and soil fertility.

The further object of this invention is to develop a method for management of plant growth or crops by using Bio-Phosphate fertilizer formulation with full of life for crop nutrition, crop productivity and soil fertility.

Yet another object is to provide an effective Bio-Phosphate fertilizer formulation with full of life for crop nutrition, crop productivity and soil fertility which is safe and environmentally friendly.

Yet another object is to provide an effective Bio-Phosphate fertilizer formulation with full of life for crop nutrition, crop productivity and soil fertility which improves the crop yield and productivity.

A further object is to provide an eco-friendly Bio-Phosphate fertilizer formulation with full of life for crop nutrition, crop productivity and soil fertility.

A further object is to provide a safe powder granular or liquid Bio-Phosphate fertilizer formulation product that does not cause any adverse effects on people.

It is a further object of the present invention to provide Bio-Phosphate fertilizer formulation product having a longer shelf life.

It is a further object of the present invention to develop Bio-Phosphate fertilizer formulation which is inexpensive and cost effective.

It is a further object of the present invention to develop Bio-Phosphate fertilizer formulation product which is easy to use with little technical expertise.

### STATEMENT OF THE INVENTION

A Bio-Phosphate fertilizer formulation with full of life for crop nutrition, crop productivity and soil fertility comprising 13 to 15% by weight of phosphate solubilizing and plant growth promoting microorganisms, 50 to 55% by weight of rock phosphate, 18 to 20% by weight of bentonite along with minerals, macro and micronutrients.

The Bio-Phosphate fertilizer formulation with full of life for crop nutrition, crop productivity and soil fertility in which the phosphate solubilizing microorganisms are selected from combination of Phosphate Solubilizing Bacteria selected from Bacillus spp & Pseudomonas spp and Phosphate Solubilizing fungi selected from Aspergillus spp and Trichoderma spp.

The Bio-Phosphate fertilizer formulation with full of life for crop nutrition, crop productivity and soil fertility in which the amount of combination of Phosphate Solubilizing Bacteria and Phosphate Solubilizing fungi is 15% by weight of total formulation at the ratio of 1:1.

The Bio-Phosphate fertilizer formulation with full of life for crop nutrition, crop productivity and soil fertility in which the Phosphate Solubilizing Bacteria selected is Bacillus megaterium.

The Bio-Phosphate fertilizer formulation with full of life for crop nutrition, crop productivity and soil fertility in which the Phosphate Solubilizing fungi selected is Aspergillus niger.

The Bio-Phosphate fertilizer formulation with full of life for crop nutrition, crop productivity and soil fertility in which the Phosphate Solubilizing Bacteria and Plant growth promoting bacteria selected is Pseudomonas fluorescens.

The Bio-Phosphate fertilizer formulation with full of life for crop nutrition, crop productivity and soil fertility in which the amount of the Pseudomonas fluorescens is 2-3% by weight of total formulation.

The Bio-Phosphate fertilizer formulation with full of life for crop nutrition, crop productivity and soil fertility in which the amount of rock phosphate is 50-55% by weight of total formulation.

The Bio-Phosphate fertilizer formulation with full of life for crop nutrition, crop productivity and soil fertility in which the amount of bentonite is 18-20% by weight of total formulation.

The Bio-Phosphate fertilizer formulation with full of life for crop nutrition, crop productivity and soil fertility in which the nutrients are selected from amino acids, protein, carbohydrates and salts.

The Bio-Phosphate fertilizer formulation with full of life for crop nutrition, crop productivity and soil fertility in which the amount of amino acids, protein, carbohydrates and salts is 3-5% by weight of total formulation.

The Bio-Phosphate fertilizer formulation with full of life for crop nutrition, crop productivity and soil fertility in which the amount of micronutrients and minerals is 2-3% by weight of total formulation.

The developed formulation of Bio-Phosphate fertilizer formulation with full of life for crop nutrition, crop productivity and soil fertility is in the form of granular form or powder form or liquid form with partially or fully soluble in water.

The Bio-Phosphate fertilizer formulation with full of life for crop nutrition, crop productivity and soil fertility is in the granular form.

A process for preparation of Bio-Phosphate fertilizer formulation with full of life for crop nutrition, crop productivity and soil fertility comprising:
a. mixing of the 50 to 55% by weight of rock phosphate, 18 to 20% by weight of bentonite along with minerals, macro and micronutrients by blending them properly to form the uniform mixture;
b. then to the above mixture at step (a) is mixed with 13 to 15% by weight of culture of combination of Bacillus megaterium and Aspergillus spp;
c. then the mixture formed in the step (b) is subjected for granulation to form the granules;
d. then the granules formed at step (c) are subjected for drying at low temperature; and
e. after that, the dried granules are coated with 2-3% by weight Pseudomonas fluorescens to form the coated granules as Bio-Phosphate fertilizer formulation.

The process for preparation of Bio-Phosphate fertilizer formulation with full of life for crop nutrition, crop productivity and soil fertility uses the amount of culture of combination of Bacillus megaterium and Aspergillus spp is 13-15% by weight of total formulation at a ratio of 1:1.

The process for preparation of Bio-Phosphate fertilizer formulation with full of life for crop nutrition, crop productivity and soil fertility uses the amount of rock phosphate is 50-55% by weight of total formulation.

The process for preparation of Bio-Phosphate fertilizer formulation with full of life for crop nutrition, crop productivity and soil fertility uses the amount of bentonite is 18-20% by weight of total formulation.

The process for preparation of Bio-Phosphate fertilizer formulation with full of life for crop nutrition, crop productivity and soil fertility use the nutrients which are selected from amino acids, carbohydrates, protein and salts at the concentration of 3-5% by weight of total formulation.

The process for preparation of Bio-Phosphate fertilizer formulation with full of life for crop nutrition, crop productivity and soil fertility uses the amount of micronutrients and minerals is 2-3% by weight of total formulation.

### DETAILED DESCRIPTION OF THE INVENTION

The present disclosure relates to the Bio-Phosphate fertilizer formulation with full of life for crop nutrition, crop productivity and soil fertility. It particularly relates to the Bio-Phosphate fertilizer formulation which reduces the use of chemical fertilizer and increase nutrients use efficiency and Phosphorus bio-availability for better crop productivity and sustainable agriculture. It specifically relates to the Bio-Phosphate fertilizer formulation containing phosphate in the form of P₂O₅, microbes especially phosphate solubilizers such as Bacillus spp, Pseudomonas spp, fungi in the form of spores Aspergillus spp and Trichoderma spp, complex media of Amino Acids, proteins, salts, minerals and Carbohydrates, plant growth promoting inputs such as humate and seaweed. The invention also relates to the process for preparation of the Bio-Phosphate fertilizer formulation with full of life for crop nutrition, crop productivity and soil fertility. The invention further relates to the method for management of plant growth or crops by using Bio-Phosphate fertilizer formulation with full of life for crop nutrition, crop productivity and soil fertility.

Bio-Phosphate Preparation Details (Instance of Artwork/Formulation in Use).

### WORKING EXAMPLE

Raw Materials:
1. Bio-fertilizer liquid formulation: (prepared with CFU of 5×10\hat{ }9): 13-15% (w/w)
   a) Bacillus megaterium (Phosphate Solubilizing Bacteria) —6.5-7.5% (w/w)
   b) Aspergillus niger (Phosphate Solubilizing fungi)—6.5-7.5% (w/w)
2. Rock Phosphate (ground into fine powder of size less than 0.1 mm) 50-55% (w/w)
3. Media components (Amino acid, Protein, Carbohydrates (Sucrose and Starch) and Salt): 3-5% (w/w)
   a. Amino acid and protein: Soya hydrolysate (2-3% (w/w))
   b. Salt: Sodium chloride and Potassium chloride (1% (w/w) each)
   c. Carbohydrates-Jaggery 1-2% (w/w)
4. Plant micro-nutrient mineral media: 2-3% (w/w)
   a. Calcium carbonate: 1-2% (w/w)
   b. Sulphates of Zn, Mn and Fe: 0.5-1% (w/w) each
   c. Boron: 0.1-0.5% (w/w)
5. Bentonite: 18-20% (w/w)
6. Pseudomonas fluorescens (Phosphate Solubilizing Bacteria and Plant growth promoting bacteria) are prepared with CFU of 5×10\hat{ }9: 2-3% (w/w)

Procedure:
1. Mix 55% (w/w) Rock phosphate, 5% (w/w) media components, 2% (w/w) mineral matters and 20% (w/w) Bentonite and blend it properly for 15 minutes.
2. Then above mixture is mixed with the 10% (w/w) broth by checking the consistency of the moisture content required for moist formulation.
3. The mixed moist formulation is fed into granulator.
4. During process of granulation, spray remaining 5% (w/w) culture for proper granulation.
5. Dry the granules low temperature, until it dries completely. Keep the CFU to the >95% safe, live and efficacious in the process of drying. Dried granules are sieved and further pushed for the coating.
6. After drying process of granules, coat the granules with 2% (w/w) Pseudomonas fluorescens and coating agents.
7. Dried Granules are packed in various size bags.
Formulation containing phosphate in the form of P₂O₅ in the range of 5% to 45%.
Formulation comprising pre-biotic components in the form of complex media for microbes especially phosphate solubilizers: containing amino acids, proteins, salts, minerals and carbohydrates.
Phosphate Solubilizing Bacteria in the form of cyst or endospore of various genera such as Bacillus spp, Pseudomonas spp. and various sp.
Phosphate solubilizing Fungi in the form of spores Aspergillus spp.
Phosphate Solubilizing Bacteria with multiple functionality such as phosphate solubilization, growth promoter and immunity building in the crop plant.
Formulation enriched with various other essential minerals for optimal crop nutrition.
Formulation enriched with plant growth promoting inputs such as humate, seaweed and amino acids.
Formulation containing 1% to 15% organic carbon to enhance the microbial survivability and provide organic carbon to the crop/soil.
Formulation either in granulation form or powder form or liquid form with partially or fully soluble in water.

TABLE 1
Effect of different ingredients of Bio phosphate on shoot and root growth of Maize crop 60 Days after sowing

| | | | | | Shoot | Root | % | % | % | % |
|---|---|---|---|---|---|---|---|---|---|---|
| | | | Shoot | Root | dry | dry | Increase | Increase | Increase | Increase |
| | | | length | length | weight | weight | shoot | Root | shoot | root |
| Treatment | | Dosage | (cm) | (cm) | (gm) | (gm) | length | length | weight | weight |
| T1 | Bacillus | 10 kg/acre | 178.00 | 18.53 | 123.19 | 8.36 | 15.17 | 26.61 | 18.69 | 23.33 |
| | megaterium | | | | | | | | | |
| | (Phosphate solubalizing | | | | | | | | | |
| | bacteria) Solid granule | | | | | | | | | |
| T2 | Aspergillus niger | 10 kg/acre | 179.23 | 18.36 | 121.36 | 8.01 | 15.75 | 25.93 | 17.47 | 19.98 |
| | (Phosphate solubalizing | | | | | | | | | |
| | fungi) Solid granule | | | | | | | | | |
| T3 | Pseudomonas | 10 kg/acre | 181.23 | 18.89 | 127.87 | 8.78 | 16.68 | 28.00 | 21.67 | 26.99 |
| | fluorescens | | | | | | | | | |
| | (Phosphate solubalizing | | | | | | | | | |
| | fungi) Solid granule | | | | | | | | | |
| T4 | megaterium + Aspergillus | 10 kg/acre | 187.23 | 20.21 | 132.15 | 9.36 | 19.35 | 32.71 | 24.21 | 31.52 |
| | niger + Rock | | | | | | | | | |
| | Phosphate + Media | | | | | | | | | |
| | components (Amino acid, | | | | | | | | | |
| | Protein, Starch and Salt) + Plant | | | | | | | | | |
| | micro-nutrient mineral media + | | | | | | | | | |
| | Pseudomonas | | | | | | | | | |
| | fluorescens(Solid | | | | | | | | | |
| | granule) | | | | | | | | | |
| T5 | Rock Phosphate P2O5 (10.6%) | 25 kg/acre | 153.50 | 15.23 | 111.50 | 6.96 | 1.63 | 10.70 | 10.17 | 7.90 |
| T6 | Control | | 151.00 | 13.60 | 100.16 | 6.41 | 0.00 | 0.00 | 0.00 | 0.00 |

T1: Bacillus megaterium (Phosphate solubalizing bacteria) Solid granule,
T2: Aspergillus niger (Phosphate solubalizing fungi) Solid granule,
T3: Pseudomonas fluorescens (Phosphate solubalizing fungi) Solid granule,
T4: Bacillus megaterium + Aspergillus niger + Rock Phosphate + Media components (Amino acid, Protein, Starch and Salt) + Plant micro-nutrient mineral media + Pseudomonas fluorescens(Solid granule),
T5: Rock Phosphate P2O5 (10.6%)
T6: Control

TABLE 2
Effect on growth & yield attributes of Maize

| | | | | | | | Yield (kg acre⁻¹) | |
|---|---|---|---|---|---|---|---|---|
| | | Concentration | TDM | | | % | % | % |
| | | (cfu/gm | (g | Yield (kg acre⁻¹) | | Increase | Increase | Increase |
| Treatment | | and %) | plant⁻¹) | Grain | Stover | TDM | Grain | Stover |
| T1 | Bacillus megaterium | 10 kg/acre | | Grain | Stover | 7.67 | 10.01 | 12.98 |
| | (Phosphate solubalizing bacteria) | | | | | | | |
| | Solid granule | | | | | | | |
| T2 | Aspergillus niger | 10 kg/acre | 129.73 | 3062.00 | 3795.84 | 16.44 | 11.20 | 18.60 |
| | (Phosphate solubalizing | | | | | | | |
| | fungi) Solid granule | | | | | | | |
| T3 | Pseudomonas | 10 kg/acre | 135.06 | 3476.00 | 4009.20 | 19.74 | 21.77 | 22.93 |
| | fluorescens | | | | | | | |
| | (Phosphate solubalizing | | | | | | | |
| | fungi) Solid granule | | | | | | | |
| T4 | Bacillus megaterium + | 10 kg/acre | 157.40 | 4349.60 | 4498.44 | 31.13 | 37.48 | 31.31 |
| | Aspergillus niger + | | | | | | | |
| | Rock Phosphate + Media components | | | | | | | |
| | (Amino acid, Protein, Starch and | | | | | | | |
| | Salt) + Plant micro-nutrient | | | | | | | |
| | mineral media + Pseudomonas | | | | | | | |
| | fluorescens(Solid | | | | | | | |
| | granule) | | | | | | | |
| T5 | Rock Phosphate P2O5 (10.6%) | 25 kg/acre | 114.06 | 2912.80 | 3305.16 | 4.96 | 6.65 | 6.51 |
| T6 | Control | | 108.40 | 2719.20 | 3089.88 | 0.00 | 0.00 | 0.00 |

T1: Bacillus megaterium (Phosphate solubalizing bacteria) Solid granule,
T2: Aspergillus niger (Phosphate solubalizing fungi) Solid granule,
T3: Pseudomonas fluorescens (Phosphate solubalizing fungi) Solid granule,
T4: Bacillus megaterium + Aspergillus niger + Rock Phosphate + Media components (Amino acid, Protein, Starch and Salt) + Plant micro-nutrient mineral media + Pseudomonas fluorescens(Solid granule),
T5: Rock Phosphate P2O5 (10.6%),
T6: Control

### BRIEF DESCRIPTION OF THE FIGURES/DRAWINGS

FIG. 1: Effect of different ingredients of Bio-phosphate on Maize crop growth leading up to 60 days after sowing.

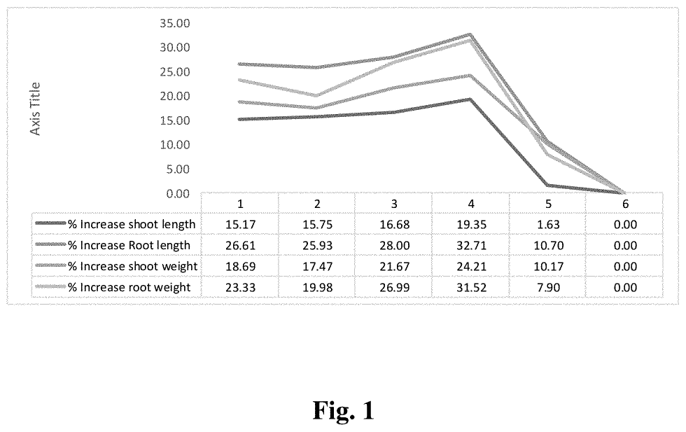

FIG. 2: Effect on growth & yield attributes of Maize at Harvesting.

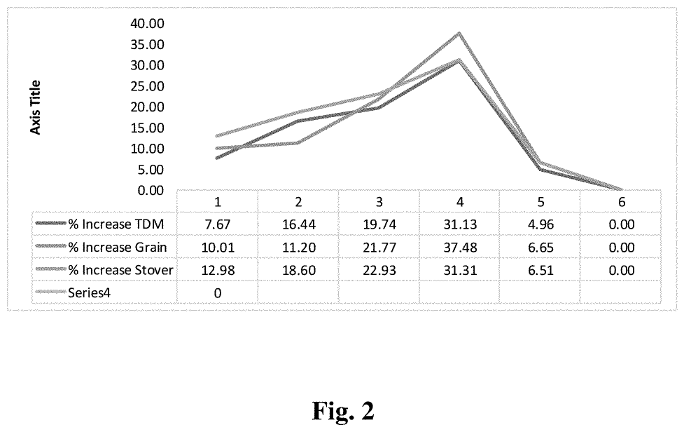

1. A Bio-Phosphate fertilizer formulation with full of life for crop nutrition, crop productivity and soil fertility comprising 13 to 15% by weight of phosphate solubilizing and plant growth promoting microorganisms, 50 to 55% by weight of rock phosphate, 18 to 20% by weight of bentonite along with minerals, macro and micronutrients.

2. The Bio-Phosphate fertilizer formulation with full of life for crop nutrition, crop productivity and soil fertility as claimed in claim 1 wherein the phosphate solubilizing microorganisms are selected from combination of Phosphate Solubilizing Bacteria selected from Bacillus spp & Pseudomonas spp and Phosphate Solubilizing fungi selected from Aspergillus spp.

3. The Bio-Phosphate fertilizer formulation with full of life for crop nutrition, crop productivity and soil fertility as claimed in claim 2 wherein the amount of combination of Phosphate Solubilizing Bacteria and Phosphate Solubilizing fungi is 13-15% by weight of total formulation at the ratio of 1:1.

4. The Bio-Phosphate fertilizer formulation with full of life for crop nutrition, crop productivity and soil fertility as claimed in claim 2 wherein the Phosphate Solubilizing Bacteria selected is Bacillus megaterium.

5. The Bio-Phosphate fertilizer formulation with full of life for crop nutrition, crop productivity and soil fertility as claimed in claim 2 wherein the Phosphate Solubilizing fungi selected is Aspergillus spp.

6. The Bio-Phosphate fertilizer formulation with full of life for crop nutrition, crop productivity and soil fertility as claimed in claim 1 wherein the Phosphate Solubilizing Bacteria and Plant growth promoting bacteria selected is Pseudomonas fluorescens.

7. The Bio-Phosphate fertilizer formulation with full of life for crop nutrition, crop productivity and soil fertility as claimed in claim 6 wherein amount of the Pseudomonas fluorescens is 2-3% by weight of total formulation.

8. The Bio-Phosphate fertilizer formulation with full of life for crop nutrition, crop productivity and soil fertility as claimed in claim 1 wherein the amount of rock phosphate is 50-55% by weight of total formulation.

9. The Bio-Phosphate fertilizer formulation with full of life for crop nutrition, crop productivity and soil fertility as claimed in claim 1 wherein the amount of bentonite is 18-20% by weight of total formulation.

10. The Bio-Phosphate fertilizer formulation with full of life for crop nutrition, crop productivity and soil fertility as claimed in claim 1 wherein the nutrients are selected from amino acids, protein, carbohydrates and salts.

11. The Bio-Phosphate fertilizer formulation with full of life for crop nutrition, crop productivity and soil fertility as claimed in claim 1 wherein the amount of amino acids, protein, carbohydrates and salts is 3-5% by weight of total formulation.

12. The Bio-Phosphate fertilizer formulation with full of life for crop nutrition, crop productivity and soil fertility as claimed in claim 1 wherein the amount of micronutrients and minerals is 2-3% by weight of total formulation.

13. The Bio-Phosphate fertilizer formulation with full of life for crop nutrition, crop productivity and soil fertility as claimed in claim 1 wherein the formulation is in the form of granular form or powder form or liquid form with partially or fully soluble in water.

14. The Bio-Phosphate fertilizer formulation with full of life for crop nutrition, crop productivity and soil fertility as claimed in claim 13 wherein the formulation is in the granular form.

15. A process for preparation of Bio-Phosphate fertilizer formulation with full of life for crop nutrition, crop productivity and soil fertility comprising:
a. mixing of the 50 to 55% by weight of rock phosphate, 18 to 20% by weight of bentonite along with minerals, macro and micronutrients by blending them properly to form the uniform mixture;
b. then to the above mixture at step (a) is mixed with 13 to 15% by weight of culture of combination of Bacillus megaterium and Aspergillus spp;
c. then the mixture formed in the step (b) is subjected for granulation to form the granules;
d. then the granules formed at step (c) are subjected for drying at low temperature; and
e. after that, the dried granules are coated with 2-3% by weight Pseudomonas fluorescens to form the coated granules as Bio-Phosphate fertilizer formulation.

16. The process for preparation of Bio-Phosphate fertilizer formulation with full of life for crop nutrition, crop productivity and soil fertility as claimed in claim 15 wherein the amount of culture of combination of Bacillus megaterium and Aspergillus niger is 13-15% by weight of total formulation at the time of preparation combination of Bacillus megaterium and Aspergillus niger is 2-5% by weight of total formulation after drying the granule formulation.

17. The process for preparation of Bio-Phosphate fertilizer formulation with full of life for crop nutrition, crop productivity and soil fertility as claimed in claim 15 wherein the amount of rock phosphate is 50-55% by weight of total formulation.

18. The process for preparation of Bio-Phosphate fertilizer formulation with full of life for crop nutrition, crop productivity and soil fertility as claimed in claim 15 wherein the amount of bentonite is 18-20% by weight of total formulation.

19. The process for preparation of Bio-Phosphate fertilizer formulation with full of life for crop nutrition, crop productivity and soil fertility as claimed in claim 15 wherein the nutrients are selected from amino acids, carbohydrates, protein and salts at the concentration of 3-5% by weight of total formulation.

20. The process for preparation of Bio-Phosphate fertilizer formulation with full of life for crop nutrition, crop productivity and soil fertility as claimed in claim 15 wherein the amount of micronutrients and minerals is 2-3% by weight of total formulation.
